(19) United States
(12) Patent Application Publication
(10) Pub. No.: US 2010/0295399 A1
(43) Pub. Date: Nov. 25, 2010

(54) MOTOR FRAME STRUCTURE

(76) Inventors: Chih-Yu Wang, Taichung City (TW); Ming-Hung Hsieh, Taichung City (TW)

Correspondence Address: Guice Patents PLLC, 12647 Galveston Court #302, Manassas, VA, 20112, US

(21) Appl. No.: 12/478,921

(22) Filed: Jun. 5, 2009

(30) Foreign Application Priority Data
May 22, 2009 (TW) 98208945

(51) Int. Cl. H02K 5/22

(52) U.S. Cl. 310/91

(57) ABSTRACT

A motor frame structure including a hollow frame shell and an outer component received in the frame shell. The motor frame structure is characterized in that the frame shell has a tubular frame body in which the outer component is received. A locating section is integrally formed on the frame body for locating the outer component in the frame shell.

### BACKGROUND OF THE INVENTION

The present invention is related to a motor, and more particularly to an improved motor frame structure.

By means of converting magnetic energy into kinetic energy, a conventional motor can output mechanical power in rotary manner. The conventional motor includes an inner component and an outer component, which are coaxially arranged. The magnetic poles of the inner and outer components have alternating polarities to alternately magnetically repel and attract each other, whereby the inner component or outer component will rotate to provide power.

No matter whether the motor is an inner rotor motor or an outer rotor motor, the outer component (outer stator or outer rotor) is generally retained in two alternative manners. In a first manner, as shown in FIG. 1, an iron core 3 is coupled with an upper ring 1 and a lower ring 2. In a second manner, the outer component is received in a shell with two open ends, which are sealed with a front cover and a rear cover. In the above manners, the outer component is retained by independent components such as the rings or the shell. Such technique requires higher assembling precision so that the assembling cost is higher. Moreover, the defects in processing and assembling the components will sum up to result in a dimensional error. This will apparently affect the quality of products.

### SUMMARY OF THE INVENTION

It is therefore a primary object of the present invention to provide an improved motor frame structure, in which the outer component is integrally formed on the frame body to reduce the number of components and shorten manufacturing time.

It is a further object of the present invention to provide the above motor frame structure, which can be manufactured at lower processing and assembling precision without affecting the quality of products.

To achieve the above and other objects, the motor frame structure of the present invention includes a hollow frame shell and an outer component received in the frame shell. The motor frame structure is characterized in that the frame shell has a tubular frame body in which the outer component is received. A locating section is integrally formed on the frame body for locating the outer component in the frame shell.

The present invention can be best understood through the following description and accompanying drawings wherein:

### BRIEF DESCRIPTION OF THE DRAWINGS

FIG. 1 is a plane view of an outer component of a conventional motor;

FIG. 2 is a perspective view of a preferred embodiment of the motor frame structure of the present invention;

FIG. 3 is a top view of the preferred embodiment of the motor frame structure of the present invention; and

FIG. 4 is a sectional view of the preferred embodiment of the motor frame structure of the present invention.

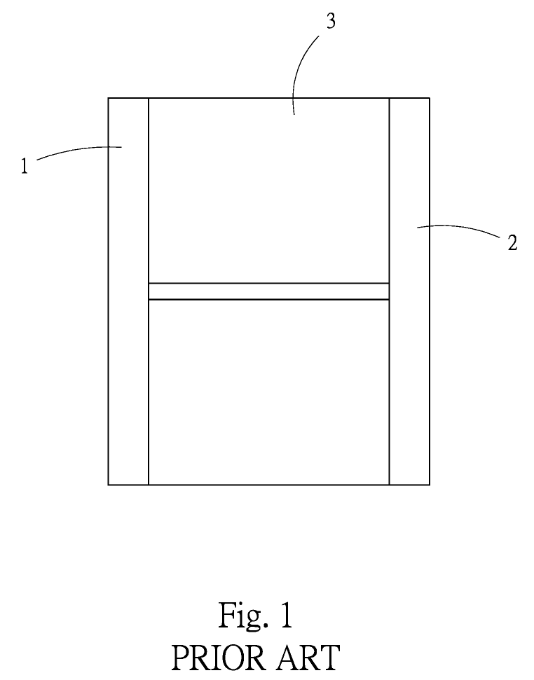

### DETAILED DESCRIPTION OF THE PREFERRED EMBODIMENT

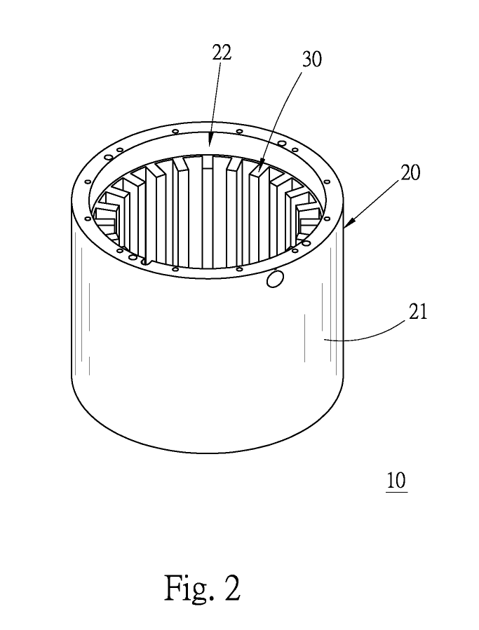

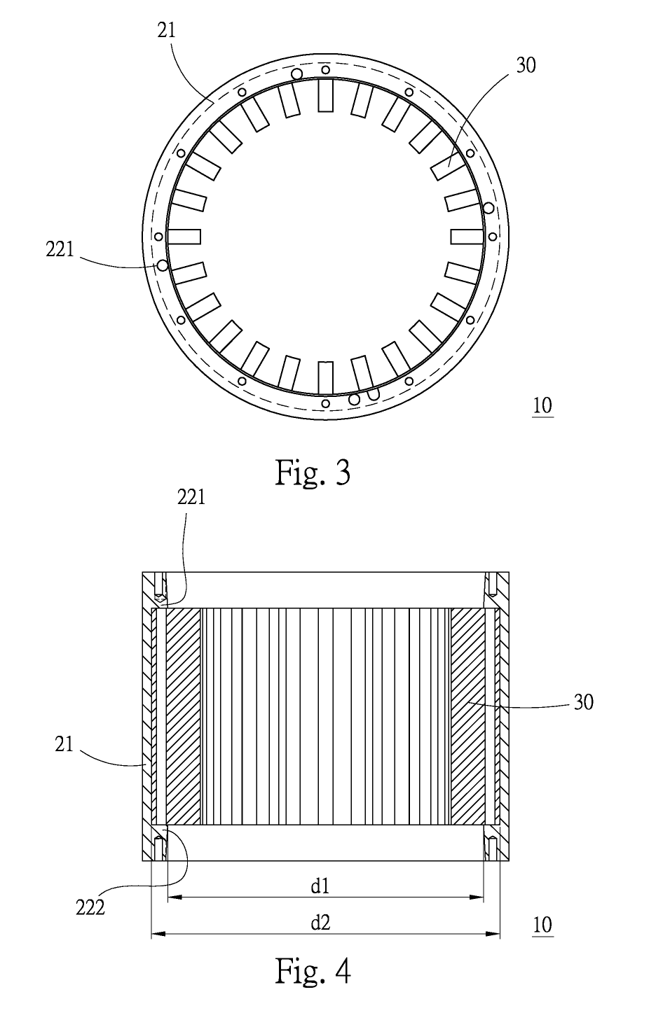

Please refer to FIGS. 2 to 4. According to a preferred embodiment, the motor frame structure 10 of the present invention includes a frame shell 20 and an outer component 30.

The frame shell 20 is hollow and has a straight tubular frame body 21 and a locating section 22 composed of two annular flanges 221, 222. The annular flanges 221, 222 are integrally formed on the frame body 21 by means of an integral molding process such as die-casting. The annular flanges 221, 222 respectively inward protrude from inner circumferences of two ends of the frame body 21. Each of the annular flanges 221, 222 has a tapered inner diameter. That is, the inner diameters of the annular flanges 221, 222 are oppositely inward tapered along the axis of the frame body 21. Accordingly, the inner diameters of the annular flanges 221, 222 at the outermost ends of the frame body 21 are slightly larger.

The outer component 30 is formed of a collar-like iron core. The outer component 30 has a length equal to the distance between the two annular flanges 221, 222. The outer component 30 has an outer diameter d2 larger than a smaller inner diameter d1 of the annular flange 221, 222 and substantially equal to the inner diameter of the frame body 21.

The outer diameter d2 of the outer component 30 is larger than the inner diameter d1 of the flange 221, 222 so that it is impossible to assemble the outer component 30 into the frame shell 20 manually or by means of a machine after the frame shell 20 is completed. Therefore, when forming the frame shell 20 by means of metal die-casting, the outer component 30 is previously placed into the die-casting mold prior to die-casting process. Then the frame shell 20 is formed by means of metal die-casting. Accordingly, when forming the frame shell 20, the outer component 30 is simultaneously located in the internal space of the frame body 21 by the annular flanges 221, 222.

According to the above arrangement of the motor frame structure 10 of the present invention, it is unnecessary to assemble the iron core in the frame shell as in the prior art. This can shorten the manufacturing time and obviate any defect caused by errors in assembling process. Moreover, when forming the frame shell 20 of the motor frame structure 10 by die-casting, the mold cavity of the mold provides stable dimension for forming the frame shell 20. Therefore, the summed up errors caused by assembling process of numerous different components in the prior art can be avoided. Also, the problems of spare material warehousing can be eliminated.

It should be noted that the present invention is not limited to an inner rotor motor with the outer component 30 formed of the iron core in the above embodiment. The present invention is also applicable to an outer rotor motor with an outer component as the rotor.

The above embodiment is only used to illustrate the present invention, not intended to limit the scope thereof. Many modifications of the above embodiment can be made without departing from the spirit of the present invention.

What is claimed is:

1. A motor frame structure comprising:
a hollow frame shell; and
an outer component received in the frame shell, the motor frame structure being characterized in that the frame shell has a tubular frame body for receiving the outer component and a locating section integrally formed on the frame body for locating the outer component in the frame shell.

2. The motor frame structure as claimed in claim 1, wherein the locating section is composed of two flanges respectively inward protruding from inner circumferences of two ends of the frame body for holding the outer component between the flanges in the frame body.

3. The motor frame structure as claimed in claim 2, wherein each of the flanges is formed with an annular configuration and has a tapered inner diameter, the inner diameters of the annular flanges being oppositely inward tapered along an axis of the frame body.

4. The motor frame structure as claimed in claim 2, wherein the two annular flanges are spaced from each other by a distance and the outer component has a length equal to the distance between the two annular flanges.

5. The motor frame structure as claimed in claim 1, wherein the outer component is an iron core.
